(19) United States
(12) Patent Application Publication
(10) Pub. No.: US 2024/0410475 A1
(43) Pub. Date: Dec. 12, 2024

(54) Ball Valve with Saddle Seals

(71) Applicant: Fieldpiece Instruments, Inc., Orange, CA (US)

(72) Inventors: Henry J. Kuo, Orange, CA (US); Nicole Antoinette Schneegas, Orange, CA (US)

(73) Assignee: Fieldpiece Instruments, Inc., Orange, CA (US)

(21) Appl. No.: 18/207,669

(22) Filed: Jun. 8, 2023

(51) Int. Cl. F16K 5/06

(52) U.S. Cl. CPC F16K 5/0684; F16K 5/0636; F16K 31/60

(57) ABSTRACT

The present design for a ball valve incorporates mating saddle seals that wrap around the valve ball and fill the valve chamber surrounding the valve ball. The sealing saddles cooperate with the existing ball valve seals upstream and downstream of the valve ball. This configuration is suitable for retrofitting existing removable ball valves currently used by technicians and may be included in new valves as well.

### FIELD OF THE INVENTIONS

The inventions described below relate to the field of tools for heating, ventilation and air conditioning setup and maintenance.

### BACKGROUND OF THE INVENTIONS

Removable ball valves used for setup and maintenance of heating, ventilation and air conditioning (HVAC) systems are represented in prior art FIGS. 1 through 8. With this prior art configuration the refrigerant is exposed to both the primary bore through the valve but also to a space, the valve chamber, surrounding the ball of the ball valve during opening or closing of the ball valve when the ball is in a position between fully open and fully closed. When the ball valve is fully open refrigerant is only exposed to the primary passage. As the ball valve is rotated to the closed position, the refrigerant is exposed to both primary passage through the valve but also to the valve chamber. The primary passage through the valve and the valve chamber are isolated from each other when the valve ball is fully open or fully closed. If refrigerant is flowing through the valve with the ball valve fully open, refrigerant is not able to escape to the valve chamber. However, during the process of opening and closing of the ball valve, refrigerant is able to escape to the valve chamber. With the refrigerant present in the valve chamber during a process of removing the refrigerant and pulling a vacuum on the HVAC refrigerant lines, a technician needs to rotate the ball valve back and forth between partly open and closed order to remove the refrigerant from the valve chamber.

If there are contaminants in the refrigerant line they also are drawn into the space surrounding the valve ball. If the technician forgets to rotate the valve between open and closed during the process of removing all the old refrigerant and the contaminants, the old refrigerant with contaminants remains in the space surrounding the valve ball. This presents potential contamination problems and is a waste of time.

### SUMMARY

To prevent refrigerant and potential contaminants from entering the space surrounding the ball valve, ball, the present design incorporates mating saddle seals that wrap around the valve ball and fill the space surrounding the valve ball. The sealing saddles cooperate with the existing ball valve seals upstream and downstream of the valve ball. This configuration is suitable for retrofitting existing removable ball valves currently used by technicians and may be included in new valves as well.

An improved ball valve has a valve housing having a first end and a second end, a main bore and a valve chamber between the first end and the second end, the valve chamber has a first and second end. The valve housing also has a first portion of the main bore extending between the first end of the valve housing and the first end of the valve chamber, the second end of the valve chamber is adjacent to the second end of the valve housing, the valve housing also has a valve stem port between the first end and the second end, the valve stem port extending through the valve housing into the valve chamber perpendicular to the main bore, a first seat ring in the valve chamber adjacent the first end of the valve chamber and a second seat ring adjacent to the second end of the valve chamber, a valve stem having a first end and a second end and a long axis extending between the first end and the second end, the valve stem extending through the valve housing within the valve stem port with the long axis of the valve stem perpendicular to the main bore, the valve stem having a handle removable secured to the first end of the valve stem and operable to rotate the valve stem about the long axis of the valve stem, a valve ball frictionally engaged between the first and second seat rings within the valve chamber, the valve ball removably secured to the second end of the valve stem and rotatable about the long axis of the valve stem, the valve ball having a central bore perpendicular to the long axis of the valve stem and operable to conduct fluid from the first end of the valve housing to the second end of the valve housing through the first portion of the main bore and the central bore of the valve ball when the valve ball is oriented between the first and second seat rings with the central bore of the valve ball colinear with the main bore, the improvement comprising: a first and second saddle seal configured to frictionally engage and surround the valve ball between the first and second seat rings and operable to seal to each other and to the first and second seat rings.

### BRIEF DESCRIPTION OF THE DRAWINGS

FIG. 1 is a top view of a prior-art ball valve for maintaining an HVAC system.

FIG. 2 is a cross-section view of the prior-art ball valve of FIG. 1 taken along A-A.

FIG. 3 is a plan view of the hose end of the prior-art ball valve of FIG. 1.

FIG. 4 is a back side view of the prior-art ball valve of FIG. 1.

FIG. 5 is a cross section view of the prior-art ball valve of FIG. 4 taken along B-B.

FIG. 6 is a plan view of the system end of the prior-art ball valve of FIG. 1.

FIG. 7 is a perspective, partial cross-section view of the prior-art valve of FIG. 1 taken along A-A with the ball valve partially open.

FIG. 8 is a cross section view of the prior-art ball valve of FIG. 4 taken along C-C with the ball valve partially open.

FIG. 9 is a perspective, partial cross-section view of a ball valve fitted with first and second saddle seals.

FIG. 10 is an exploded perspective view of a valve ball, first and second seat rings and first and second saddle seals arranged to engage to isolate the valve ball central bore from the valve chamber as illustrated in FIG. 9.

FIG. 11 is a cross section of the ball valve of FIG. 9 taken along D-D with the ball valve partially open.

FIG. 12 is a cross section of the ball valve of FIG. 9 taken along D-D with the ball valve open.

FIG. 13 is an exploded perspective view of the ball valve of FIG. 9.

### DETAILED DESCRIPTION OF THE INVENTIONS

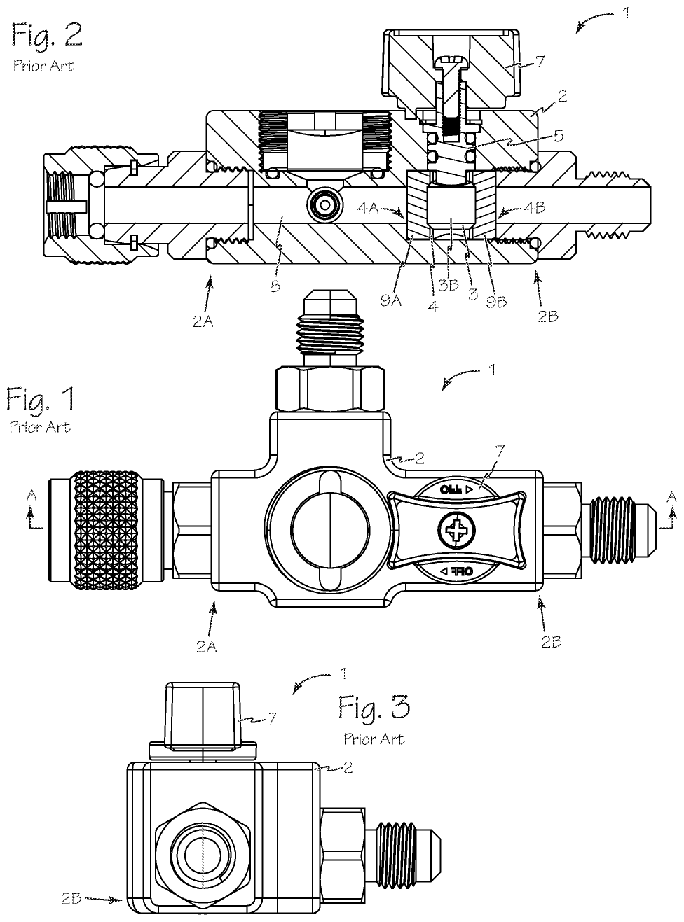

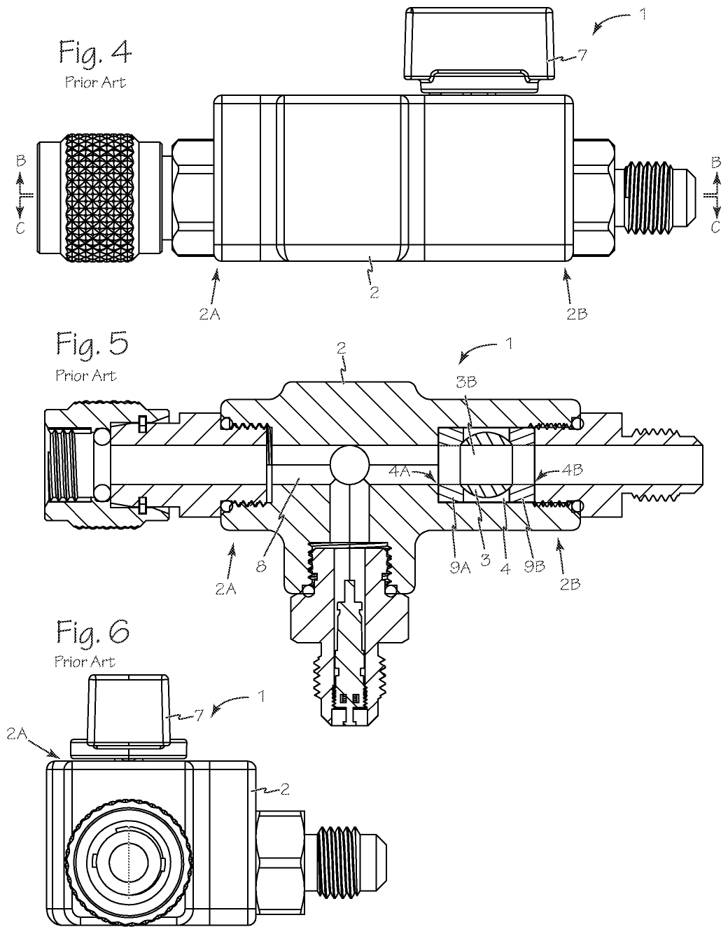

FIGS. 1 through 8 illustrate prior-art ball valve 1 with valve housing 2 the valve ball 3 in valve chamber 4. The valve ball 3 has a central bore 3B and is removably connected to valve stem 5 which extends through valve stem port 6 is removably connected to handle 7. Valve housing 2 has a first end 2A and a second end 2B and a main bore 8 in fluid communication between first end 2A and a second end 2B. Valve chamber 4 has a first end 4A and a second end 4B and encloses first seat ring 9A, valve ball 3, and second seat ring 9B.

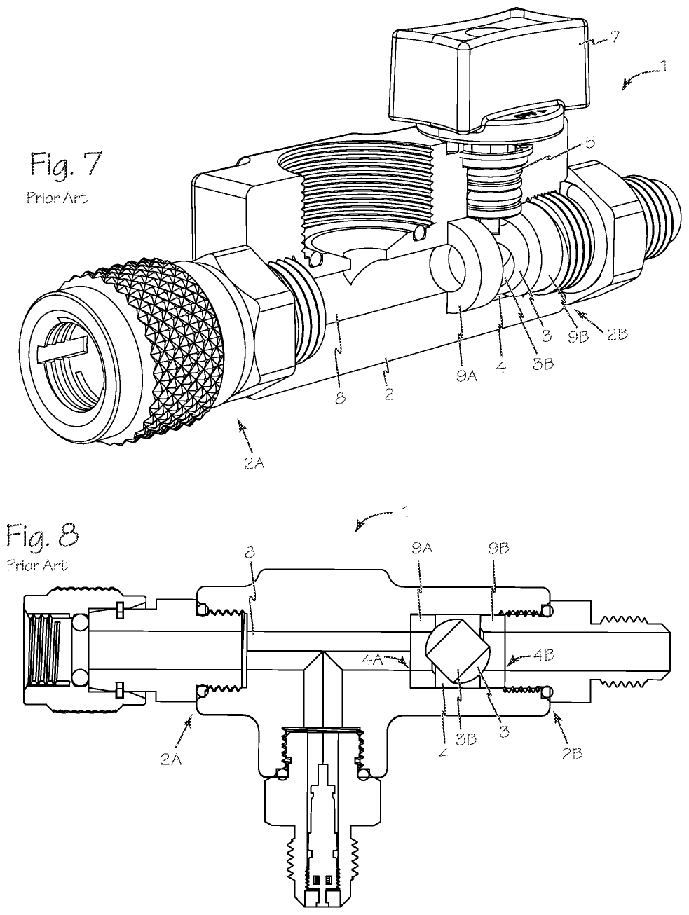

Any fluid to be controlled by the valve 1 such as refrigerant is exposed to both the main bore 8 through the valve but also to a space, the valve chamber 4, surrounding the ball 3 of the ball valve during opening or closing of the ball valve when the ball is in a position between fully open and fully closed as illustrated in FIGS. 7 and 8. When the ball valve is fully open, valve ball bore 3B is colinear with main bore 8 and the edges of valve ball bore 3B are sealed against first and second seat rings 9A and 9B, fluid such as refrigerant is only exposed to the main bore 8 and the valve ball bore 3B as illustrated in FIGS. 2 and 5. As the ball 3 is rotated to the closed position by rotating valve handle 7 about the long axis of the valve stem, the refrigerant is exposed to both the main bore 8 as well as the valve chamber 4. The main bore 8 through the valve and the valve chamber 4 are isolated from each other by first and second seat rings 9A and 9B when the valve ball 3 is fully open or fully closed as illustrated in FIGS. 2 and 5. If a fluid such as refrigerant is flowing through the valve 1 with the ball valve fully open, refrigerant is not able to escape to the valve chamber 4. However, during the process of opening and closing of the ball valve, refrigerant is able to escape to the valve chamber 4. With the refrigerant present in the valve chamber during a process of removing the refrigerant and pulling a vacuum on the HVAC refrigerant lines, a technician needs to rotate the ball valve back and forth between open and closed using handle 7 order to remove any refrigerant from the valve chamber 4.

If there are contaminants in the refrigerant lines, the contaminants also are drawn into the valve chamber 4 surrounding the valve ball. If the technician forgets, or does not assiduously rotate the valve between open and closed during the process of removing all the old refrigerant and the contaminants, the old refrigerant with contaminants remains in the space surrounding the valve ball. This is a potential problem and waste of time.

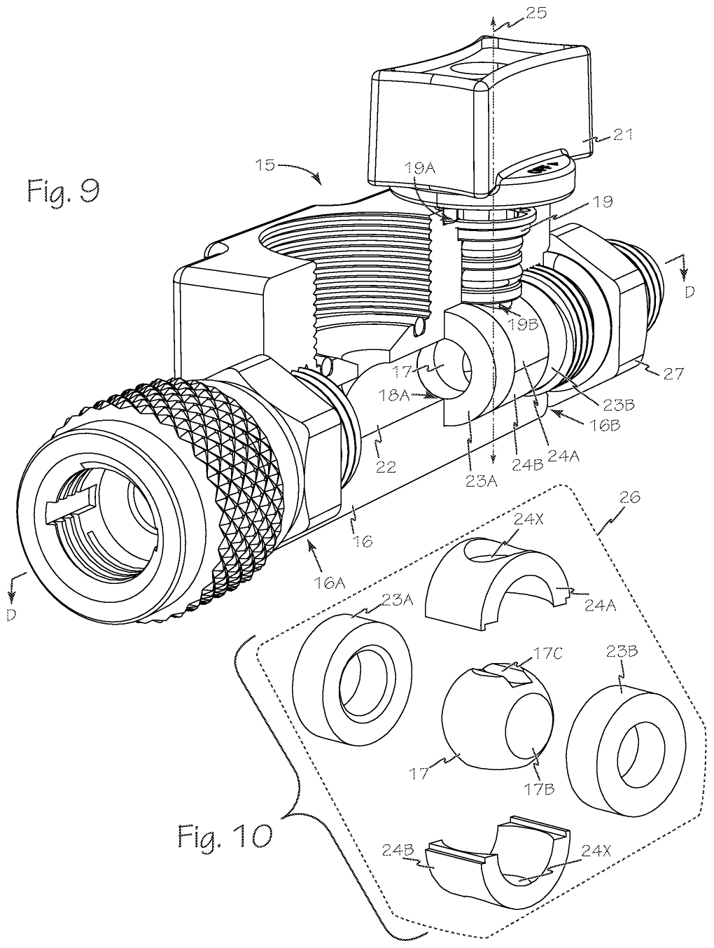

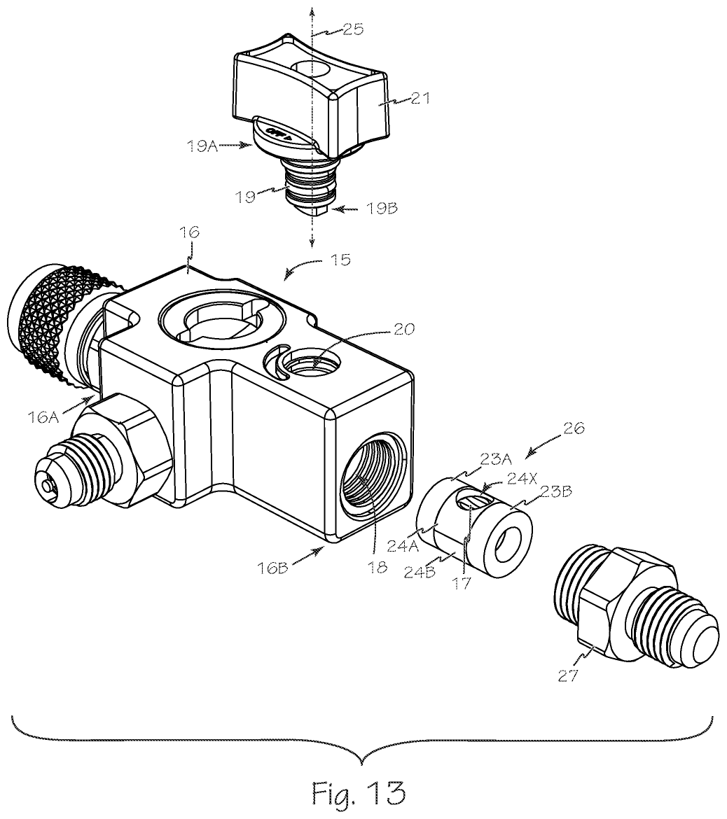

Referring now to FIGS. 9 through 13, ball valve 15 has a valve housing 16, a valve ball 17 in valve chamber 18. The valve ball 17 includes valve ball bore 17B and is removably connected via connector 17C to valve stem 19 which extends through valve stem port 20 and is removably connected to handle 21. Valve housing 16 has a first end 16A and a second end 16B and a main bore 22 in fluid communication between first end 16A and a second end 16B. Valve chamber 18 has a first end 18A and a second end 18B and encloses first seat ring 23A, valve ball 17, and second seat ring 23B as well as first and second saddle seals 24A and 24B respectively. Valve stem 19 has a long axis 25 extending from the top or first end 19A to the bottom or second end 19B. The first and second saddle seals 24A and 24B provide sealing to valve ball bore 17B when it rotates between fully open and fully closed.

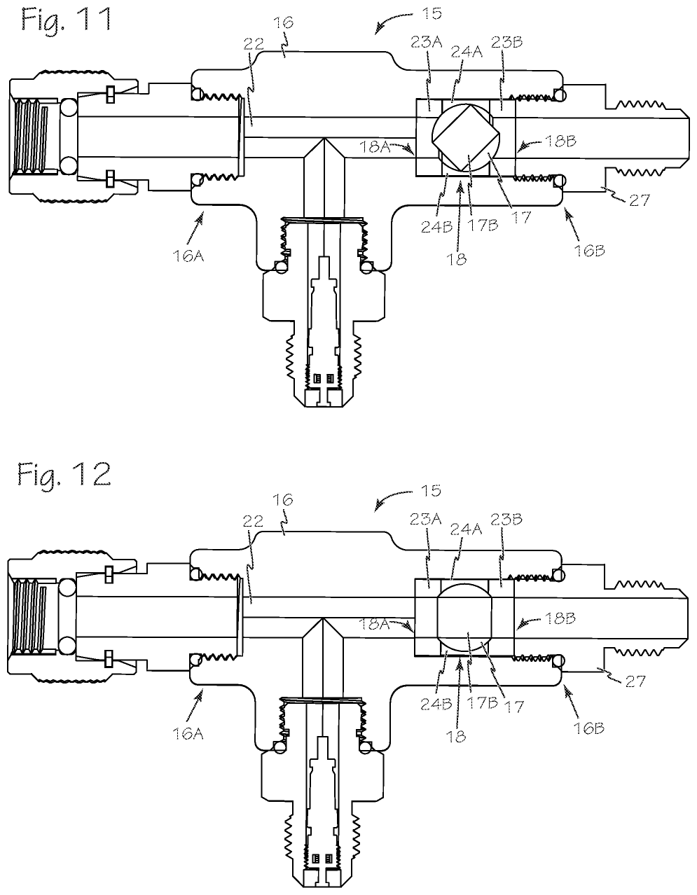

As discussed above with respect to prior art valve 1, any fluid to be controlled by the valve 15 such as refrigerant is exposed to both the main bore 22 through the valve but also to the valve ball bore 17B during opening or closing of the ball valve when the ball is in a position between fully open and fully closed as illustrated in FIGS. 9 and 11. Unlike the prior art valve, valve chamber 18 is filled with valve ball 17, first and second seat rings 23A and 23B as well as first and second saddle seals 24A and 24B. The first and second seat rings and the first and second saddle seals provide sealing to valve ball bore 17B through its entire range of motion about long axis 25 when the handle 21 and valve stem 19 are turned. When the ball valve is fully open, valve ball bore 17B is colinear with main bore 22 and the edges of valve ball bore 17B are sealed against first and second seat rings 23A and 23B, fluid such as refrigerant is only exposed to the main bore 22 and the valve ball bore 17B as illustrated in FIGS. 11 and 12. As the valve ball 17 is rotated to the closed position by rotating valve handle 21 about the long axis of the valve stem, the edges of the valve ball bore engage the saddle seals 24A and 24B and any fluid encountering the saddle seals is pushed into the valve ball bore 17B or into the openings of either the first or second seat rings 23A and or 23B and no fluid escapes into the valve chamber 18.

In the configuration of valve 15, ball valve assembly 26 may be easily removed, serviced and replaced. Removal of second end fitting 27 and valve stem 19 enables the removal of valve ball 17, first and second seat rings 23A and 23B as well as first and second saddle seals 24A and 24B through the second end 16B of the valve housing 16. The first and second saddle seals 24A and 24B are interchangeable and include access port 24X to permit the bottom or second end 19B of valve stem 19 to engage valve ball 17.

While the preferred embodiments of the devices and methods have been described in reference to the environment in which they were developed, they are merely illustrative of the principles of the inventions. The elements of the various embodiments may be incorporated into each of the other species to obtain the benefits of those elements in combination with such other species, and the various beneficial features may be employed in embodiments alone or in combination with each other. Other embodiments and configurations may be devised without departing from the spirit of the inventions and the scope of the appended claims.

We claim:

1. A ball valve comprising:
a valve housing having a first end and a second end, a main bore and a valve chamber between the first end and the second end, the valve chamber having a first end and a second end, the valve housing also having a first portion of the main bore extending between the first end of the valve housing and the first end of the valve chamber, the second end of the valve chamber is adjacent to the second end of the valve housing, the valve housing also having a valve stem port between the first end and the second end extending through the valve housing into the valve chamber perpendicular to the main bore;
a first seat ring in the valve chamber adjacent the first end of the valve chamber and a second seat ring adjacent to the second end of the valve chamber;
a valve stem having a first end and a second end and a long axis extending between the first end and the second end, the valve stem extending through the valve housing within the valve stem port with the long axis of the valve stem perpendicular to the main bore, the valve stem having a handle removable secured to the first end of the valve stem and operable to rotate the valve stem about the long axis of the valve stem;
a valve ball frictionally engaged between the first and second seat rings within the valve chamber, the valve ball removably secured to the second end of the valve stem and rotatable about the long axis of the valve stem, the valve ball having a central bore perpendicular to the long axis of the valve stem and operable to conduct fluid from the first end of the valve housing to the second end of the valve housing through the first portion of the main bore and the central bore of the valve ball when the valve ball is oriented between the first and second seat rings with the central bore of the valve ball colinear with the main bore; and
a first and second saddle seal configured to frictionally engage and surround the valve ball central bore between the first and second seat rings and operable to seal to each other and to the first and second seat rings.

2. The ball valve of claim 1 wherein the first and second saddle seals are similar and each saddle seal has a valve stem port to enable the valve stem to engage the valve ball through either the first or second saddle seal.

3. The ball valve of claim 1 further comprising:
a second portion of the main bore between the second end of the valve housing and the second end of the valve chamber, the second portion of the main bore colinear with the first portion of the main bore.

4. An improved ball valve has a valve housing having a first end and a second end, a main bore and a valve chamber between the first end and the second end, the valve chamber has a first and second end, the valve housing also has a first portion of the main bore extending between the first end of the valve housing and the first end of the valve chamber, the second end of the valve chamber is adjacent to the second end of the valve housing, the valve housing also has a valve stem port between the first end and the second end, the valve stem port extending through the valve housing into the valve chamber perpendicular to the main bore, a first seat ring in the valve chamber adjacent the first end of the valve chamber and a second seat ring adjacent to the second end of the valve chamber, a valve stem having a first end and a second end and a long axis extending between the first end and the second end, the valve stem extending through the valve housing within the valve stem port with the long axis of the valve stem perpendicular to the main bore, the valve stem having a handle removable secured to the first end of the valve stem and operable to rotate the valve stem about the long axis of the valve stem, a valve ball frictionally engaged between the first and second seat rings within the valve chamber, the valve ball removably secured to the second end of the valve stem and rotatable about the long axis of the valve stem, the valve ball having a central bore perpendicular to the long axis of the valve stem and operable to conduct fluid from the first end of the valve housing to the second end of the valve housing through the first portion of the main bore and the central bore of the valve ball when the valve ball is oriented between the first and second seat rings with the central bore of the valve ball colinear with the main bore, the improvement comprising:
a first and second saddle seal configured to frictionally engage and surround the valve ball central bore between the first and second seat rings and operable to seal to each other and to the first and second seat rings.

5. The improved ball valve of claim 5 wherein the first and second saddle seals are similar and each saddle seal has a valve stem port to enable the valve stem to engage the valve ball through either the first or second saddle seal.

6. The improved ball valve of claim 5 wherein the first and second ring seats and the first and second saddle seals and the valve ball are available as a replacement assembly to enable retrofitting existing ball valves.

7. A method of sealing a ball valve having a valve housing, a second end fitting and a valve stem operably connected to the valve ball at a valve stem connection and first and second ring seats frictionally engaging the valve ball, the valve ball and the first and second ring seats collocated in a valve chamber comprising the steps:
Removing the second end fitting;
removing the valve stem from the valve housing;
removing the second ring seat and the valve ball from the valve chamber;
installing a first and second saddle seal around the valve ball with the valve stem connection oriented within a valve stem opening in the first saddle seal;
installing the first and second saddle seals and the valve ball into the valve chamber;
installing the second ring seat in the valve chamber; and
operably connecting the valve stem through the valve housing and the first saddle seal to the valve stem connection on the valve ball.
